(19) United States
(12) Patent Application Publication
(10) Pub. No.: US 2025/0344130 A1
(43) Pub. Date: Nov. 6, 2025

(54) METHOD AND APPARATUS FOR COMMUNICATION IN AN IAB NETWORK

(71) Applicant: LENOVO (BEIJING) LIMITED, Beijing (CN)

(72) Inventors: Yibin ZHUO, Shanghai (CN); Mingzeng DAI, Shanghai (CN); Lianhai WU, Beijing (CN); Le YAN, Shanghai (CN)

(21) Appl. No.: 18/725,363

(22) PCT Filed: Dec. 31, 2021
(86) PCT No.: PCT/CN2021/143725

§ 371 Date: Jun. 28, 2024

(51) Int. Cl. H04W 40/24; H04L 45/00; H04W 88/08

(52) U.S. Cl. CPC H04W 40/248; H04L 45/22; H04W 88/08

(57) ABSTRACT

Embodiments of the present disclosure relate to wireless communication in an integrated access and backhaul (IAB) network. According to some embodiments of the disclosure, a method performed by a network node may include: receiving a header rewriting configuration, wherein each entry of the header rewriting configuration indicates an ingress BAP routing ID, an egress BAP routing ID, and a next hop BAP address for the egress BAP routing ID; and performing a BAP header rewriting procedure based on the header rewriting configuration.

### TECHNICAL FIELD

Embodiments of the present disclosure generally relate to communication technology, and more particularly to communication in an integrated access and backhaul (IAB) network.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

To extend the coverage and availability of wireless communication systems (e.g., 5G systems), the 3rd generation partnership project (3GPP) is envisioning integrated access and backhaul (IAB) architecture for supporting multi-hop relays. In an IAB network, an IAB node may hop through one or more IAB nodes before reaching a base station (also referred to as “an IAB donor” or “a donor node”). A single hop may be considered a special instance of multiple hops. Multi-hop backhauling is beneficial because it provides a relatively greater coverage extension compared to single-hop backhauling. In a relatively high frequency radio communication system (e.g., radio signals transmitted in frequency bands over 6 GHz), relatively narrow or less signal coverage may benefit from multi-hop backhauling techniques.

The industry desires technologies for handling wireless communications in the IAB network.

### SUMMARY

Some embodiments of the present disclosure provide a network node. The network node may include a transceiver, wherein the transceiver may be configured to receive a header rewriting configuration, wherein each entry of the header rewriting configuration indicates an ingress BAP routing ID, an egress BAP routing ID, and a next hop backhaul adaptation protocol (BAP) address for the egress BAP routing ID. The network node may further include a processor coupled to the transceiver, wherein the processor may be configured to perform a BAP header rewriting procedure based on the header rewriting configuration.

Some embodiments of the present disclosure provide a first base station (BS). The first BS may include: a processor; and a transceiver coupled to the processor. The transceiver may be configured to: receive, from a second base station, information related to a backup backhaul adaptation protocol (BAP) routing ID for rerouting; and transmit, to a network node connected to the first base station and the second base station, a header rewriting configuration for rerouting based on the received information.

In some embodiments of the present disclosure, the transceiver may be further configured to transmit, to the second base station, a request for the backup BAP routing ID for rerouting. In some embodiments of the present disclosure, the request for the backup BAP routing ID for rerouting may indicate at least one of: the number of backup BAP routing IDs; or an identifier of the network node. In some embodiments of the present disclosure, the header rewriting configuration for rerouting may indicate a next hop BAP address for the backup BAP routing ID.

Some embodiments of the present disclosure provide a second base station (BS). The second BS may include: a processor; and a transceiver coupled to the processor. The transceiver may be configured to: receive, from a first base station, a request for a backup backhaul adaptation protocol (BAP) routing ID for rerouting; and transmit, to the first base station, information related to the backup BAP routing ID for rerouting.

In some embodiments of the present disclosure, the request for the backup BAP routing ID for rerouting may indicate at least one of: the number of backup BAP routing IDs; or an identifier of a network node connected to the first base station and the second base station.

Some embodiments of the present disclosure provide a first base station (BS). The first BS may include: a processor; and a transceiver coupled to the processor. The transceiver may be configured to: transmit, to a second base station, QoS information of at least one of downlink (DL) traffic or uplink (UL) traffic for inter-topology routing; and receive, from the second base station, a rejection or a partial admission of the at least one of DL traffic or UL traffic.

In some embodiments of the present disclosure, the partial admission may indicate at least one of: a list of unadmitted backhaul adaptation protocol (BAP) routing IDs associated with the first base station, a list of unadmitted backhaul (BH) radio link control (RLC) channels (CHs) associated with the first base station, a list of unadmitted F1-U tunnels associated with the first base station, a list of admitted BAP routing IDs associated with the first base station, a list of admitted BH RLC CHs associated with the first base station, or a list of admitted F1-U tunnels associated with the first base station; or In some embodiments of the present disclosure, the partial admission may indicate an available offloading capability of the second base station.

In some embodiments of the present disclosure, the transceiver may be further configured to transmit a header rewriting configuration for inter-topology routing to a network node connected to the first base station and the second base station based on the partial admission, and the header rewriting configuration for inter-topology routing may indicate a next hop BAP address for an egress BAP routing ID associated with the second base station.

Some embodiments of the present disclosure provide a second base station (BS). The second BS may include: a processor; and a transceiver coupled to the processor. The transceiver may be configured to: receive, from a first base station, QoS information of at least one of downlink (DL) traffic or uplink (UL) traffic for inter-topology routing; and transmit, to the first base station, a rejection or a partial admission of the at least one of DL traffic or UL traffic.

In some embodiments of the present disclosure, the partial admission may indicate at least one of: a list of unadmitted backhaul adaptation protocol (BAP) routing IDs associated with the first base station, a list of unadmitted backhaul (BH) radio link control (RLC) channels (CHs) associated with the first base station, a list of unadmitted F1-U tunnels associated with the first base station, a list of admitted BAP routing IDs associated with the first base station, a list of admitted BH RLC CHs associated with the first base station, or a list of admitted F1-U tunnels associated with the first base station. In some embodiments of the present disclosure, the partial admission may indicate an available offloading capability of the second base station.

Some embodiments of the present disclosure provide a method performed by a network node. The method may include: receiving a header rewriting configuration, wherein each entry of the header rewriting configuration indicates an ingress BAP routing ID, an egress BAP routing ID, and a next hop backhaul adaptation protocol (BAP) address for the egress BAP routing ID; and performing a BAP header rewriting procedure based on the header rewriting configuration.

Some embodiments of the present disclosure provide a method performed by a first base station (BS). The method may include: receiving, from a second base station, information related to a backup backhaul adaptation protocol (BAP) routing ID for rerouting; and transmitting, to a network node connected to the first base station and the second base station, a header rewriting configuration for rerouting based on the received information.

Some embodiments of the present disclosure provide a method performed by a second base station (BS). The method may include: receiving, from a first base station, a request for a backup backhaul adaptation protocol (BAP) routing ID for rerouting; and transmitting, to the first base station, information related to the backup BAP routing ID for rerouting.

Some embodiments of the present disclosure provide a method performed by a first base station (BS). The method may include: transmitting, to a second base station, QoS information of at least one of downlink (DL) traffic or uplink (UL) traffic for inter-topology routing; and receiving, from the second base station, a rejection or a partial admission of the at least one of DL traffic or UL traffic.

Some embodiments of the present disclosure provide a method performed by a second base station (BS). The method may include: receiving, from a first base station, QoS information of at least one of downlink (DL) traffic or uplink (UL) traffic for inter-topology routing; and transmitting, to the first base station, a rejection or a partial admission of the at least one of DL traffic or UL traffic.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an example block diagram of a protocol stack for an IAB network in accordance with some embodiments of the present disclosure;

FIG. 3 illustrates an example block diagram of a protocol stack for an IAB network in accordance with some embodiments of the present disclosure;

FIG. 4 illustrates an exemplary routing and BH RLC channel selection procedure in accordance with some embodiments of the present disclosure;

FIG. 5 illustrates an exemplary topology redundancy case in accordance with some embodiments of the present disclosure;

FIG. 6 illustrates an exemplary migration case in accordance with some embodiments of the present disclosure;

FIG. 7 illustrates a flow chart of an exemplary procedure of wireless communications in accordance with some embodiments of the present disclosure;

FIG. 8 illustrates a flow chart of an exemplary procedure of wireless communications in accordance with some embodiments of the present disclosure;

FIG. 9 illustrates a flow chart of an exemplary procedure of wireless communications in accordance with some embodiments of the present disclosure; and

FIG. 10 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

Compared with the 4G communication system, the 5G communication system has raised more stringent requirements for various network performance indicators, for example, 1000-times capacity increase, wider coverage requirements, ultra-high reliability, ultra-low latency, etc. Considering the rich frequency resources of high-frequency carriers, the use of high-frequency small station deployments is becoming more and more popular in hotspot areas in order to meet the needs of 5G ultra-high capacity. However, high-frequency carriers have poor propagation characteristics, severe attenuation due to obstructions, and limited coverage. Therefore, the dense deployment of small stations is required. In addition, the deployment of optical fiber may be difficult and costly for these small stations. Therefore, an economical and convenient backhaul scheme is needed. Integrated access and backhaul (IAB) technology, whose access link(s) and backhaul link(s) may both use wireless transmission solutions to avoid fiber deployment, provides ideas for solving the above problems.

In an IAB network, a relay node (RN) or an IAB node or a wireless backhaul node/device can provide wireless access services for UEs. That is, a UE can connect to an IAB donor relayed by one or more IAB nodes. The IAB donor may also be called a donor node or a donor base station (e.g., DgNB, Donor gNodeB). In addition, the wireless link between an IAB donor and an IAB node, or the wireless link between different IAB nodes can be referred to as a “backhaul link.”

An IAB node may include an IAB mobile terminal (MT) part and an IAB distributed unit (DU) part. When an IAB node connects to its parent node (which may be another IAB node or an IAB donor), it can be regarded as a UE, i.e., the role of an MT. When an IAB node provides service to its child node (which may be another IAB node or a UE), it can be regarded as a network device, i.e., the role of a DU.

An IAB donor can be an access network element with a complete base station function, or an access network element with a separate form of a centralized unit (CU) and a distributed unit (DU). The IAB donor may be connected to the core network (for example, connected to the 5G core network (5GC)), and provide the wireless backhaul function for the IAB nodes. The CU of an IAB donor may be referred to as an “IAB donor-CU” (or directly referred to as a “CU”), and the DU of the IAB donor may be referred to as an “IAB donor-DU.” The IAB donor-CU may be separated into a control plane (CP) and a user plane (UP). For example, a CU may include one CU-CP and one or more CU-UPs.

Considering the small coverage of a high frequency band, in order to ensure the coverage performance of the network, multi-hop networking may be adopted in an IAB network. Taking into account the requirements of service transmission reliability, IAB nodes can support dual connectivity (DC) or multi-connectivity to improve the reliability of transmission, so as to deal with abnormal situations that may occur on the backhaul (BH) link, such as radio link failure (RLF) or blockage, load fluctuations, etc.

In the case where an IAB network supports multi-hop and dual-connection networking, there may be multiple transmission paths between the UE and the IAB donor. A transmission path may include multiple nodes, such as a UE, one or more IAB nodes, and an IAB donor (if the IAB donor is in the form of a separate CU and DU, it may also contain an IAB donor-DU and an IAB donor-CU). Each IAB node may treat the neighboring node that provides backhaul services for it as a parent node (or parent IAB node), and each IAB node can be regarded as a child node (or child IAB node) of its parent node.

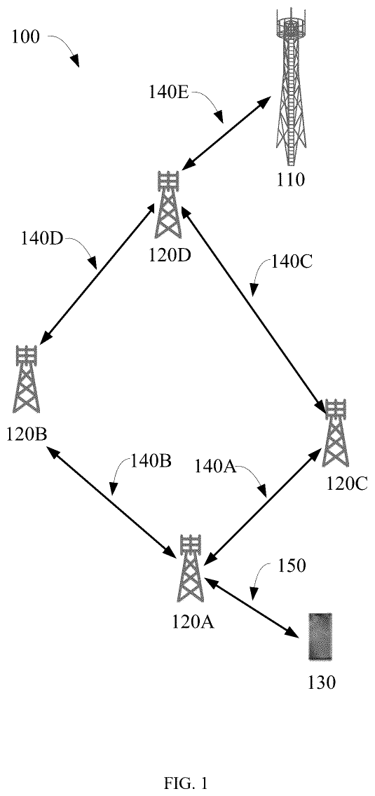

FIG. 1 illustrates a schematic diagram of a wireless communication system 100 in accordance with some embodiments of the present disclosure.

As shown in FIG. 1, the wireless communication system 100 may include a base station (e.g., IAB donor 110), some IAB nodes (e.g., IAB node 120A, IAB node 120B, IAB node 120C, and IAB node 120D), and a UE (e.g., UE 130). Although a specific number of UEs, IAB nodes, and IAB donors are depicted in FIG. 1, it is contemplated that any number of UEs, IAB nodes, and IAB donors may be included in the wireless communication system 100.

Each of IAB donor 110, IAB node 120A, IAB node 120B, IAB node 120C and IAB node 120D may be directly connected to one or more IAB nodes in accordance with some other embodiments of the present disclosure. Each of IAB donor 110, IAB node 120A, IAB node 120B, IAB node 120C and IAB node 120D may be directly connected to one or more UEs in accordance with some other embodiments of the present disclosure.

UE 130 may be any type of device configured to operate and/or communicate in a wireless environment. For example, UE 130 may include a computing device, such as a desktop computer, a laptop computer, a personal digital assistant (PDA), a tablet computer, a smart television (e.g., television connected to the Internet), a set-top box, a game console, a security system (including a security camera), a vehicle on-board computer, a network device (e.g., router, switch, and modem), or the like. According to some embodiments of the present disclosure, UE 130 may include a portable wireless communication device, a smart phone, a cellular telephone, a flip phone, a device having a subscriber identity module, a personal computer, a selective call receiver, or any other device that is capable of transmitting and receiving communication signals on a wireless network. In some embodiments of the present disclosure, UE 130 may include wearable devices, such as smart watches, fitness bands, optical head-mounted displays, internet-of-things (IoT) devices, or the like. Moreover, UE 130 may be referred to as a subscriber unit, a mobile, a mobile station, a user, a terminal, a mobile terminal, a wireless terminal, a fixed terminal, a subscriber station, a user terminal, or a device, or described using other terminology used in the art.

IAB donor 110 may be in communication with a core network (not shown in FIG. 1). The core network (CN) may include a plurality of core network components, such as a mobility management entity (MME) (not shown in FIG. 1) or an access and mobility management function (AMF) (not shown in FIG. 1). The CNs may serve as gateways for the UEs to access a public switched telephone network (PSTN) and/or other networks (not shown in FIG. 1).

Wireless communication system 100 may be compatible with any type of network that is capable of transmitting and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, IAB donor 110 may transmit data using an orthogonal frequency division multiple (OFDM) modulation scheme on the DL. UE 130 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

Persons skilled in the art should understand that as technology develops and advances, the terminologies described in the present disclosure may change, but should not affect or limit the principles and spirit of the present disclosure.

Referring to FIG. 1, IAB node 120D can be directly connected to IAB donor 110. IAB donor 110 is a parent node of IAB node 120D. In other words, IAB node 120D is a child IAB node of IAB donor 110. IAB nodes 120B and 120C can reach IAB donor 110 by hopping through IAB node 120D. IAB node 120D is a parent IAB node of IAB nodes 120B and 120C. In other words, IAB nodes 120B and 120C are child IAB nodes of IAB node 120D.

IAB node 120A can be connected to IAB node 120B so it can reach IAB donor 110 by hopping through IAB node 120B and IAB node 120D. IAB node 120A and IAB node 120B may be referred to as the downstream (or descendant) IAB nodes of IAB node 120D. IAB node 120B and IAB node 120D may be referred to as the upstream IAB nodes of IAB node 120A. IAB node 120A can also be connected to IAB node 120C so it can reach IAB donor 110 by hopping through IAB node 120C and IAB node 120D.

UE 130 can be connected to IAB node 120A. Uplink (UL) packets (e.g., data or signaling) from UE 130 can be transmitted to an IAB donor (e.g., IAB donor 110) via one or more IAB nodes, and then transmitted by the IAB donor to a mobile gateway device (such as the user plane function (UPF) in 5GC). Downlink (DL) packets (e.g., data or signaling) can be transmitted from the IAB donor (e.g., IAB donor 110) after being received by the gateway device, and then transmitted to UE 130 through one or more IAB nodes. For example, referring to FIG. 1, UE 130 may transmit UL data to IAB donor 110 or receive DL data therefrom via IAB node 120A.

In an IAB deployment such as the wireless communication system 100, the radio link between an IAB donor (e.g., IAB donor 110 in FIG. 1) and an IAB node or between two IAB nodes may be referred to as a backhaul link (BL). The radio link between an IAB donor (e.g., IAB donor 110 in FIG. 1) and a UE or between an IAB node and a UE may be referred to as an access link (AL). For example, in FIG. 1, radio links 140A to 140E are BLs and radio link 150 is an AL.

An egress BH link may refer to a BH link on which a packet is transmitted by a node (e.g., an IAB node or IAB donor). An ingress BH link may refer to a BH link on which a packet is received by a node (e.g., an IAB node or IAB donor). An egress BH RLC channel may refer to a BH RLC channel on which a packet is transmitted by a node (e.g., an IAB node or IAB donor). An ingress BH RLC channel may refer to a BH RLC channel on which a packet is received by a node (e.g., an IAB node or IAB donor). For example, from the perspective of IAB node 120B, an egress BH RLC channel may refer to a BH RLC channel between 120B and 120D or a BH RLC channel between IAB nodes 120B and 120A. For instance, for UL, an egress BH RLC channel of IAB node 120B may refer to a BH RLC channel between IAB nodes 120B and 120D; and for DL, an egress BH RLC channel of IAB node 120B may refer to a BH RLC channel between IAB nodes 120B and 120A.

A protocol layer, the backhaul adaptation protocol (BAP) layer, located above the radio link control (RLC) layer, is introduced in an IAB system and can be used to realize packet routing, bearer mapping and flow control on the wireless backhaul link.

An F1 interface may be established between an IAB node (e.g., the DU part of the IAB node) and an IAB donor (e.g., IAB donor-CU). The F1 interface may support both a user plane protocol (e.g., F1-U) and a control plane protocol (e.g., F1-C). The user plane protocol of the F1 interface may include one or more of a general packet radio service (GPRS) tunneling protocol user plane (GTP-U), user datagram protocol (UDP), internet protocol (IP) and other protocols. The control plane protocol of the F1 interface may include one or more of an F1 application protocol (F1AP), stream control transport protocol (SCTP), IP, and other protocols.

Through the control plane of the F1 interface, an IAB node and an IAB donor can perform, for example, interface management, IAB-DU management, and a UE context-related configuration. Through the user plane of the F1 interface, an IAB node and an IAB donor can perform, for example, user plane data transmission and downlink transmission status feedback functions.

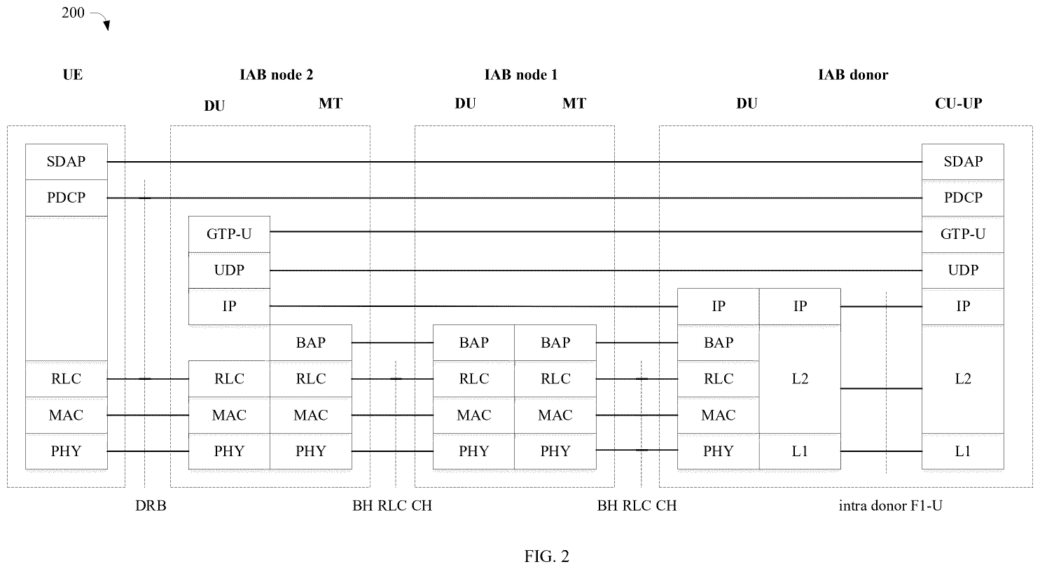

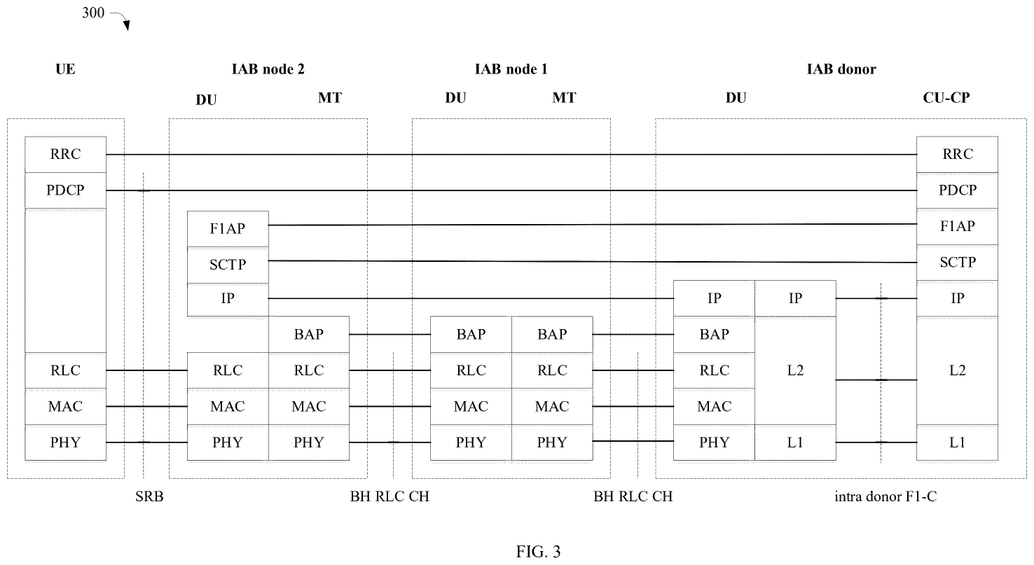

FIG. 2 illustrates an example block diagram of a user plane (UP) protocol stack 200 for an IAB network according to some embodiments of the present disclosure. FIG. 3 illustrates an example block diagram of a control plane (CP) protocol stack 300 for an IAB network according to some embodiments of the present disclosure. In FIGS. 2 and 3, a UE may be connected to an IAB donor via IAB node 2 and IAB node 1.

Referring to FIG. 2, the UP protocol stack of the UE may include a service data adaptation protocol (SDAP) layer, a packet data convergence protocol (PDCP) layer, a radio link control (RLC) layer, a medium access control (MAC) layer, and a physical (PHY) layer. The UP protocol stack of the DU of IAB node 2 may include a GTP-U layer, a UDP layer, an IP layer, an RLC layer, a MAC layer, and a PHY layer.

The UP protocol stack of the MT of IAB node 2 or the DU or MT of IAB node 1 may include a BAP layer, an RLC layer, a MAC layer, and a PHY layer. The UP protocol stack of the DU of the IAB donor may include an IP layer, a BAP layer, an RLC layer, a MAC layer, and a PHY layer, where the PHY layer belongs to layer 1 (L1), and the BAP layer, the RLC layer, and the MAC layer belong to layer 2 (L2). The protocol stack of the CU-UP of the IAB donor may include a GTP-U layer, a UDP layer, an IP layer, a SDAP layer, a PDCP layer, an L2 layer(s), and an L1 layer.

Referring to FIG. 3, the CP protocol stack of the UE may include a radio resource control (RRC) layer, a PDCP layer, an RLC layer, a MAC) layer, and a physical (PHY) layer. The CP protocol stack of the DU of IAB node 2 may include an F1AP layer, an SCTP layer, an IP layer, an RLC layer, a MAC layer, and a PHY layer. The CP protocol stack of the MT of IAB node 2 or the DU or MT of IAB node 1 may include a BAP layer, an RLC layer, a MAC layer, and a PHY layer. The CP protocol stack of the DU of the IAB donor may include an IP layer, a BAP layer, an RLC layer, a MAC layer, and a PHY layer, where the PHY layer belongs to L1, and the BAP layer, the RLC layer, and the MAC layer belong to L2. The protocol stack of the CU-CP of the IAB donor may include an RRC layer, a PDCP layer, an F1AP layer, an SCTP layer, an IP layer, an L2 layer(s), and an L1 layer.

The protocol stacks shown in FIGS. 2 and 3 are only for illustrative purposes. For example, the sequences of some of the protocol layers in the protocol stacks of FIGS. 2 and 3 may be rearranged for illustrative purposes. For example, although the SDAP and PDCP layers belong to L2, they are shown above the GTP-U layer, the UDP layer and the IP layer in the protocol stack of the CU-UP of the IAB donor in FIG. 2.

An IAB-node with a radio resource control (RRC) interface terminating at a different IAB donor-CU than the F1 interface may be referred to as a “boundary IAB-node”. This definition may apply to application scenarios including, for example, partial migration, inter-donor redundancy and inter-donor RLF recovery.

Routing, rerouting, and BAP header rewriting may be supported on the BAP layer (which, in some embodiments, may also be referred to as “BAP sublayer”). Embodiments of the present disclosure provide solutions for facilitating the routing, rerouting, and BAP header rewriting procedures. More details on the embodiments of the present disclosure will be illustrated in the following text in combination with the appended drawings.

In some embodiments of the present disclosure, routing on a BAP layer may use a BAP routing ID, which may be configured by an IAB donor-CU. The BAP routing ID may include a BAP address which indicates the BAP address of a destination node in the BH link. The destination nodes of a DL BH link and a UL BH link may be an access IAB node and an IAB donor-DU, respectively. The BAP routing ID may also include a BAP path identity (ID) which indicates the routing path terminated at the destination node. The BAP address may be used for the following purposes:
(1) Determination whether a packet has reached the destination node, e.g., an IAB node or an IAB donor-DU, on the BAP layer. This is the case if the BAP address in the BAP header of the packet matches the BAP address configured via RRC on the IAB node, or via F1AP on the IAB donor-DU.
(2) Determination of the next-hop node for a packet that has not reached its destination. This may apply to a packet arriving from a prior-hop node on the BAP layer or that has been received from the IP layer of the current node.

In some embodiments of the present disclosure, BAP routing may be performed based on a routing configuration. For example, an IAB node may determine the next-hop node for a packet arriving from a prior hop or from its upper layer(s) based on the routing configuration. Such routing configuration may be provided by an IAB donor-CU via, for example, F1AP signaling, or may be a default configuration provided by the IAB donor-CU via, for example, RRC signaling. A routing configuration may include a mapping between a BAP routing ID and the BAP address of the next-hop node. The routing configuration may include at least one entry of such mapping.

Table 1 below shows an exemplary routing configuration. It should be understood that Table 1 is only for illustrative purposes, and should not be construed as limiting the embodiments of the present disclosure. In some examples, a “BAP routing ID” in Table 1 may be represented by a corresponding “(destination) BAP address” and “BAP path ID.”

TABLE 1
Routing configuration

| BAP routing ID | Next-hop BAP address |
|---|---|
| Derived from BAP packet's BAP | Egress link to forward the packet |
| header | |

An IAB node may resolve the next-hop BAP address to a physical backhaul link. To gain this end, an IAB donor-CU may provide the IAB node or the IAB donor-DU with the BAP address of its child node via, for example, F1AP signaling. The IAB donor-CU may provide the IAB node with the BAP address of its parent-node via, for example, RRC signaling.

In some examples, an IAB node may receive a routing configurations including a plurality of entries with the same destination BAP address but different BAP path IDs. These routing entries may resolve to the same or different egress BH links.

For example, an IAB node may derive a BAP routing ID from the BAP header of a packet (e.g., a BAP data PDU). For example, the BAP header may include a DESTINATION field and a PATH field, indicating the destination and routing path of the packet, respectively. The IAB node may look up a routing configuration to select an egress link for transmitting the packet based on the derived BAP routing ID.

In some examples, the selected BH link may be unavailable for the packet. In this scenario, the IAB node may perform a local rerouting procedure. For example, the IAB node select another BH link by considering only the BAP address of the packet and disregarding the BAP path ID of the packet. For instance, the IAB node may reroute the packet to an available egress link in the routing configuration with the same destination BAP address and a different BAP path ID, which can be referred to as “intra-DU rerouting.” In this manner, the packet can be delivered via an alternative path.

A BH link may be considered unavailable in the case that the BH link has a radio link failure (RLF). A single-connected IAB node (e.g., only connected to a single parent node), that has migrated from a source parent node to a target parent node, may consider the BH link to the source parent unavailable for UL packets of descendent nodes. A BH link may be considered unavailable due to congestion, which may be derived from DL or UL flow-control feedback information.

In some embodiments of the present disclosure, an IAB node may perform a BAP routing procedure and a BAP rerouting procedure (e.g., intra-DU rerouting) according to the following pseudo-code.

For a BAP Data PDU to be transmitted, the BAP entity shall:
if the BAP Data PDU corresponds to a BAP SDU received from the upper layer, and
if the BH Routing Configuration has not been (re) configured by F1AP after the last (re) configuration of defaultUL-BH-RLC-channel by RRC:
   select the egress link on which the egress BH RLC channel corresponding to defaultUL-BH-RLC-channel is configured for non-F1-U packets;
else if there is an entry in the BH Routing Configuration whose BAP address matches the DESTINATION field, whose BAP path identity (ID) is the same as the PATH field, and whose egress link corresponding to the Next Hop BAP Address is available:
   select the egress link corresponding to the Next Hop BAP Address of the entry;
[NOTE 1: An egress link is not considered to be available if the link is in BH RLF.]
[NOTE 2: For each combination of a BAP address and a BAP path identity, there should be at most one entry in the BH Routing Configuration. There could be a plurality of entries of the same BAP address in the BH Routing Configuration.]
else if there is at least one entry in the BH Routing Configuration whose BAP address matches the DESTINATION field, and whose egress link corresponding to the Next Hop BAP Address is available:
   select an entry from the BH Routing Configuration whose BAP address is the same as the DESTINATION field, and whose egress link corresponding to the Next Hop BAP Address is available;
   select the egress link corresponding to the Next Hop BAP Address of the entry selected above.

In some embodiments of the present disclosure, when routing a packet from an ingress BH link to an egress BH link, an IAB node may derive the egress BH RLC channel on the egress BH link from the ingress BH RLC channel used on the ingress BH link, according to a BH RLC channel mapping configuration. The RLC channel mapping configuration may be configured via F1AP signaling. The BH RLC channel IDs used for ingress and egress BH RLC channels may be generated by an IAB donor-CU. In some examples, the BH RLC channel ID may only have a link-local scope. For example, BH RLC channels on different BH links may have the same ID. The RLC channel mapping configuration may also include the BAP addresses of the prior hop and next hop.

Table 2 below shows an exemplary RLC channel mapping configuration. It should be understood that Table 2 is only for illustrative purposes, and should not be construed as limiting the embodiments of the present disclosure.

TABLE 2
RLC channel mapping configuration

| Next-hop BAP | Prior-hop BAP | Ingress RLC | Egress RLC |
|---|---|---|---|
| address | address | channel ID | channel ID |
| Derived from | Derived from | Derived from | BH RLC channel |
| routing | packet's ingress | packet's ingress | on egress link to |
| configuration | link | BH RLC channel | forward packet |

An IAB node may resolve a BH RLC channel ID (e.g., the ingress BH RLC channel ID) from a logical channel ID based on, for example, the configuration by the IAB donor-CU. In some examples, the MT of the IAB node may obtain the BH RLC channel ID in an RRC configuration of the corresponding logical channel. In some examples, the DU of the IAB node may obtain the BH RLC channel ID in an F1AP configuration of the BH RLC channel.

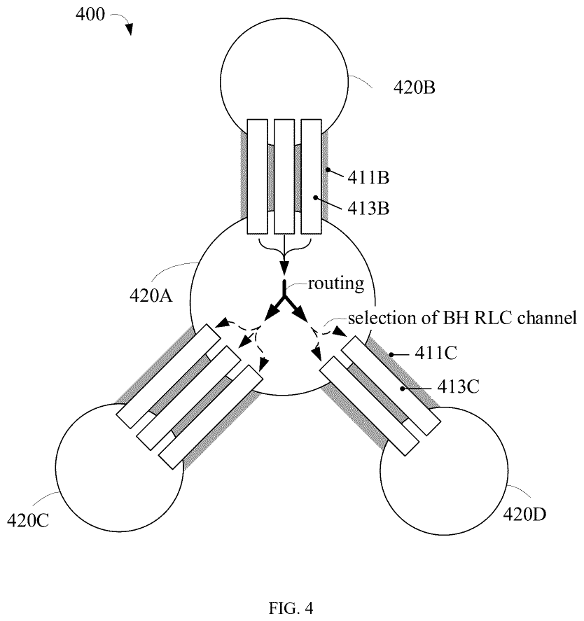

FIG. 4 illustrates an exemplary routing and BH RLC channel selection procedure 400 in accordance with some embodiments of the present disclosure. Details described in all of the foregoing embodiments of the present disclosure are applicable for the embodiments shown in FIG. 4.

Referring to FIG. 4, IAB node 420A may receive a packet from a prior-hop node 420B, which may be a child node of IAB node 420A for UL transmission, or a parent node of IAB node 420A for DL transmission. IAB node 420A may connect to next-hop nodes 420C and 420D, which may be parent nodes of IAB node 420A for UL transmission, or child nodes of IAB node 420A for DL transmission.

IAB node 420A may receive the packet on ingress BH RLC channel 413B on ingress BH link 411B. IAB node 420A may perform a routing procedure based on a routing configuration to select an available egress BH link 411C. IAB node 420A may further select a BH RLC channel on egress BH link 411C based on an RLC channel mapping configuration. For example, IAB node 420A may egress BH RLC channel 413C. IAB node 420A may transmit the packet on egress BH RLC channel 413C on egress BH link 411C to next-hop node 420D.

In some embodiments of the present disclosure, an IAB-node may rewrite the BAP routing ID in the BAP header of a packet under, for example but not limited to, the following circumstances:
(1) A packet is routed between two topologies by a boundary IAB-node (the definition of which is specified in the 3GPP specifications). This may be referred as “inter-topology routing”. In this case, the BAP routing ID carried by the received BAP PDU may be allocated by the IAB donor-CU of the ingress topology, while the BAP routing ID carried by the transmitted BAP PDU may be allocated by the IAB donor-CU of the egress topology.
(2) An upstream packet is locally re-routed to a different IAB donor-DU (target donor DU) than indicated by the destination in the BAP header of the received packet (also referred to as “inter-DU rerouting”). The rerouting may be triggered by, for example, an RLF or congestion of egress link. The target donor DU can be a donor DU within the same CU as the original destination DU or a DU of another CU. The rewritten BAP header may carry the BAP address of the target donor DU and the BAP path ID for a path to the target donor DU. BAP header rewriting for upstream inter-DU rerouting may only be applied in the case that neither routing nor local re-routing without header rewriting resolve to an available BH link.

The BAP header rewriting procedure may be performed based on a BAP header rewriting configuration, which may be configured via, for example, F1AP signaling. The BAP header rewriting configuration may include a mapping between an ingress BAP routing ID and an egress BAP routing ID. The BAP header rewriting configuration may include at least one entry of such mapping.

Table 3 below shows an exemplary BAP header rewriting configuration. It should be understood that Table 3 is only for illustrative purposes, and should not be construed as limiting the embodiments of the present disclosure.

TABLE 3
BAP header rewriting configuration

| Ingress BAP routing ID | Egress BAP routing ID |
|---|---|
| BAP routing ID carried in the BAP | BAP routing ID carried in the BAP |
| header of received BAP PDU | header of transmitted BAP PDU |

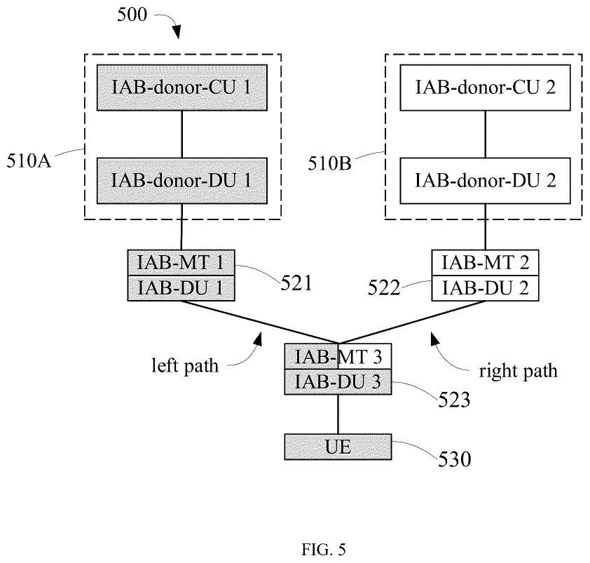

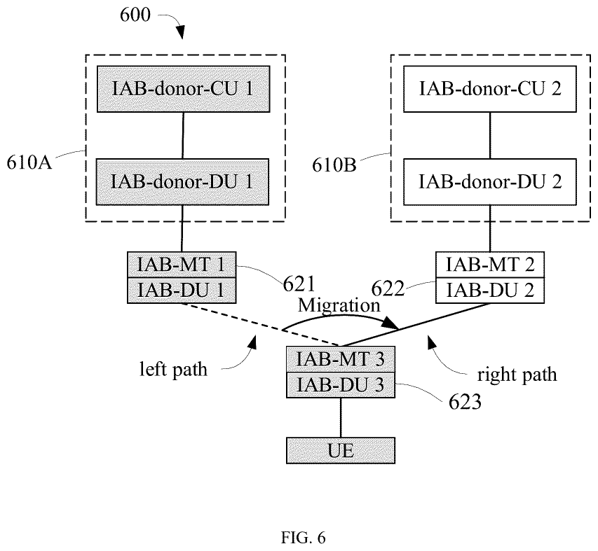

FIG. 5 illustrates an exemplary topology redundancy case 500 in accordance with some embodiments of the present disclosure. FIG. 6 illustrates an exemplary migration case 600 in accordance with some embodiments of the present disclosure. Details described in all of the foregoing embodiments of the present disclosure are applicable for the embodiments shown in FIGS. 5 and 6.

FIG. 5 shows an exemplary topology redundancy case where IAB node 523 may have a connection to both IAB donor 510A and IAB donor 510B. IAB donor 510A may include IAB-donor-CU1 and IAB-donor-DU1, and IAB donor 510B may include IAB-donor-CU2 and IAB-donor-DU2. IAB node 521 may connect to IAB donor 510A and may include IAB-MT 1 and IAB-DU 1, and IAB node 522 may connect to IAB donor 510B and may include IAB-MT 2 and IAB-DU 2. IAB node 523 may include IAB-MT 3 and IAB-DU 3. IAB node 523 may connect to IAB donor 510A via IAB node 521, and may connect to IAB donor 510B via IAB node 522.

In some examples, IAB-MT 3 may connect to both IAB-donor-CU1 and IAB-donor-CU2, and IAB-DU 3 may connect to IAB-donor-CU1. In this case, IAB-donor-CU1 can also be referred to as an “F1-terninating CU”, and IAB-donor-CU2 can be referred to as a “non-F1-terninating CU”.

Although the exemplary topology redundancy case in FIG. 5 shows that IAB node 523 connects to two donor-CUs, it is contemplated that IAB node 523 may connect to different IAB-donor-DUs associated with the same CU, or the same IAB-donor-DU via different upstream nodes in other topology redundancy cases.

FIG. 6 shows exemplary a migration case, where the MT (IAB-MT 3) of IAB node 623 may migrate from IAB-donor-CU1 to IAB-donor-CU2. Referring to FIG. 6, IAB donor 610A may include IAB-donor-CU1 and IAB-donor-DU1, and IAB donor 610B may include IAB-donor-CU2 and IAB-donor-DU2. IAB node 621 may connect to IAB donor 610A and may include IAB-MT 1 and IAB-DU 1, and IAB node 622 may connect to IAB donor 610B and may include IAB-MT 2 and IAB-DU 2. IAB node 623 may include IAB-MT 3 and IAB-DU 3.

Before the migration of IAB node 623, IAB node 623 can reach IAB donor 610A via IAB node 621. Both IAB-MT 3 and IAB-DU 3 may be anchored at IAB-donor-CU1. After the migration of IAB node 623, IAB-MT 3 may be migrated from IAB donor 610A to IAB donor 610B and IAB-DU 3 may still be under the control of IAB-donor-CU1. That is, after the migration, IAB-MT 3 may be anchored at IAB-donor-CU2 and IAB-DU 3 may still be anchored at IAB-donor-CU1. Thus, IAB-donor-CU1 can be referred to as an “F1-terninating CU”, and IAB-donor-CU2 can be referred to as a “non-F1-terninating CU”.

In both the topology redundancy case and migration case, for example, as shown in FIGS. 5 and 6, a packet may be delivered in the right path. IAB-donor-CU1 and IAB-donor-CU2 in FIG. 5 or 6 may need to negotiate with each other in order to enable the routing via the right path since the BAP routing ID and BH RLC CH allocation may be unique within each IAB donor-CU.

Taking UL traffic as an example, IAB-donor-CU1 in FIG. 5 or 6 may need to inform IAB-donor-CU2 in FIG. 5 or 6 of the QoS information of the UL ingress traffic and accordingly old BAP routing ID and ingress BH RLC CH in the ingress topology of IAB-donor-CU1. IAB-donor-CU2 may feed back to IAB-donor-CU1 the new BAP routing ID and egress BH RL CH respectively in the egress topology of IAB-donor-CU2. IAB-donor-CU1 may configure an IAB node (e.g., IAB node 523 or 623) with the routing configuration which includes the rewriting mapping configuration to map an old BAP routing ID to a new BAP routing ID. For example, the ingress BAP routing ID and the egress BAP routing ID as shown in Table 3 may respectively denote the old BAP routing ID and new BAP routing ID. For an IAB node (e.g., IAB node 523 or 623), in response to receiving, from a child node, a UL packet which is planned to be offloaded to, for example, the right path as shown in FIG. 5 or 6, the BAP entity of the IAB node may rewrite the UL packet according to the rewriting mapping configuration.

Under certain circumstances, inter-topology rerouting may occur. For example, referring back to FIG. 5, UL traffic may be configured to be transmitted from UE 530 to IAB-donor-CU1 via IAB node 523, IAB node 521, and IAB-donor-DU 1. In some cases, the BH link between IAB node 521 and IAB node 523 may be unavailable, for example, suffering from an RLF or congestion. The UL traffic may be rerouted via another transmission path, for example, via IAB node 522 and IAB-donor-DU 2. In response to the reception of the rerouted UL traffic, IAB-donor-DU 2 may transmit it to IAB-donor-DU 1 via, for example, an IP tunnel between IAB-donor-DU 1 and IAB-donor-DU 2.

To perform such rerouting, header rewriting configuration for rerouting may need to be configured for the boundary node (e.g., IAB node 523). Embodiments of the present disclosure provide solutions for determining and configuring the header rewriting configuration for rerouting.

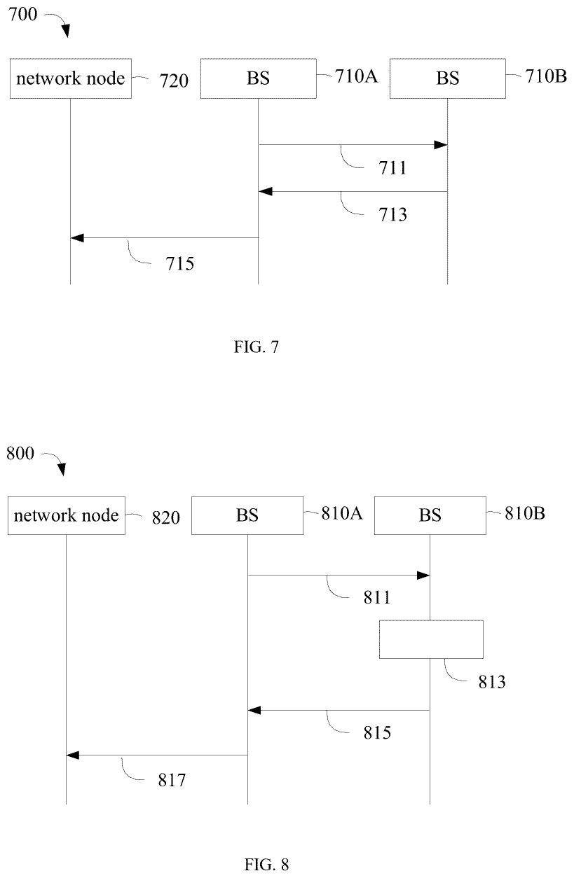

For example, FIG. 7 illustrates a flow chart of an exemplary procedure 700 of wireless communications in accordance with some embodiments of the present disclosure. Details described in all of the foregoing embodiments of the present disclosure are applicable for the embodiments shown in FIG. 7.

Referring to FIG. 7, network node 720 may function as an IAB node such as IAB node 523 in FIG. 5. BSs 710A and 710B may function as an IAB donor or the CU of an IAB donor. Network node 720 may be connected to both BSs 710A and 710B, which may respectively include an F1-terminating CU and a non-F1-terminating CU of network node 720. For example, BSs 710A and 710B may function as IAB donors 510A and 510B in FIG. 5, respectively.

In operation 711, BS 710A may transmit a request for a backup BAP routing ID for rerouting to BS 710B. In operation 713, in response to the request, BS 710B may transmit information related to the backup BAP routing ID for rerouting to BS 710A. In some examples, at least one DU of BS 710B may have setup a tunnel with a DU of BS 710A. In some examples, the backup BAP routing ID may be associated with at least one DU of BS 710B, and each of the at least one DU of BS 710B may have a connection to network node 720. In operation 715, BS 710A may transmit a header rewriting configuration for rerouting to network node 720 based on the information received from BS 710B.

In some embodiments of the present disclosure, the request may include the number of backup BAP routing IDs. The information related to the backup BAP routing ID for rerouting may include at least one of: at least one backup BAP routing ID associated with BS 710B, or a corresponding next hop BAP address for each of the at least one backup BAP routing ID associated with BS 710B.

In these embodiments, BS 710A may determine the mapping between the old BAP routing ID (i.e., BAP routing ID associated with BS 710A) and the backup (new) BAP routing ID (i.e., BAP routing ID associated with BS 710B), which may correspond to the ingress BAP routing ID and the egress BAP routing ID in a header rewriting configuration for rerouting as will be described in the following text.

In some embodiments of the present disclosure, the request may include information related to at least one BAP routing ID associated with BS 710A (old BAP routing ID or ingress BAP routing ID). The information related to the backup BAP routing ID for rerouting may include at least one of: a mapping between a BAP routing ID of the at least one BAP routing ID associated with BS 710A and a corresponding backup BAP routing ID associated with BS 710B (new BAP routing ID or egress BAP routing ID), or a next hop BAP address for the corresponding backup BAP routing ID associated with BS 710B. For example, a mapping between each of the at least one BAP routing ID associated with BS 710A and a corresponding backup BAP routing ID associated with BS 710B may be included.

In some examples, the request may further include an identifier of network node 720. For example, a plurality of network nodes may require a header rewriting configuration for rerouting. The request may include the identifiers of the network nodes. The identifier of a network node may be the identifier of an IAB-MT or IAB-DU.

In some examples, the request in operations 711 and the response in operation 713 may be transmitted via an XnAP procedure including, for example but not limited to, the following. A dedicated information element(s) (IE(s)) may be employed in the procedure to carry the request, the response, or both.
SN addition procedure (S-NODE ADDITION REQUEST and S-NODE ADDITION REQUEST ACKNOWLEDGE);
MN initiated SN modification procedure (S-NODE MODIFICATION REQUEST and S-NODE MODIFICATION REQUEST ACKNOWLEDGE); or
SN initiated SN modification procedure (S-NODE MODIFICATION REQUIRED and S-NODE MODIFICATION CONFIRM).

In some embodiments of the present disclosure, the header rewriting configuration for rerouting may include at least one entry, each of which may map an old BAP routing ID (or an ingress BAP routing ID) to a corresponding backup BAP routing ID associated with BS 710B (or an egress BAP routing ID). In some examples, the entry may further a next hop BAP address for the corresponding backup BAP routing ID. In this way, when network node 720 performs the header rewriting procedure (e.g., for rerouting from BS 710A to BS 710B), network node 720 can conveniently determine the egress link based on the next hop BAP address. Otherwise, in the case that the next hop BAP address is not included, network node 720 may need to request a BH routing configuration associated with the new BAP routing ID (e.g., backup BAP routing ID associated with BS 710B).

It should be appreciated by persons skilled in the art that the sequence of the operations in exemplary procedure 700 may be changed and some of the operations in exemplary procedure 700 may be eliminated or modified, without departing from the spirit and scope of the disclosure.

Under certain circumstances, a packet may be offloaded to another path. For example, as shown in FIGS. 5 and 6, a packet may be offloaded from the left path to the right path. However, IAB-donor-CU2 may not be able to take all the offloaded traffic from IAB-donor-CU1. For example, IAB-donor-CU2 may not have such capability. Embodiments of the present disclosure provide solutions for inter-topology routing which can solve the above issue.

For example, FIG. 8 illustrates a flow chart of an exemplary procedure 800 of wireless communications in accordance with some embodiments of the present disclosure. Details described in all of the foregoing embodiments of the present disclosure are applicable for the embodiments shown in FIG. 8. In the exemplary procedure 800, a BS may reject the offload request or partially admit the offloaded traffic.

Referring to FIG. 8, network node 820 may function as an IAB node such as IAB node 523 in FIG. 5 or IAB node 623 in FIG. 6. BSs 810A and 810B may function as an IAB donor or the CU of an IAB donor. Network node 820 may be connected to both BSs 810A and 810B, which may respectively include the F1-terminating CU and non-F1-terminating CU of network node 820. For example, BS 810A may function as IAB donor 510A in FIG. 5 or IAB donor 610A in FIG. 6, and BS 810B may function as IAB donor 510B in FIG. 5 or IAB donor 610B in FIG. 6.

In operation 811, BS 810A may transmit the QOS information of at least one of a DL traffic (e.g., DL egress traffic) or a UL traffic (e.g., UL ingress traffic) for inter-topology routing to BS 810B. BS 810A may perform the operation in order to offload the DL or UL traffic associated with the QoS information to BS 810B. For example, the QoS information may be transmitted in an offload request. In some examples, the offload request may be a handover request from BS 810A to BS 810B. In some examples, the offload request may be a second node addition request from BS 810A to BS 810B.

In some examples, for UL ingress traffic, a corresponding ingress BAP routing ID and ingress BH RLC CH in the ingress topology may also be transmitted. In some examples, for DL egress traffic, a corresponding egress BAP routing ID and egress BH RLC CH in the egress topology may also be transmitted. In some examples, an F1-U tunnel for the UL ingress traffic or DL egress traffic may also be transmitted.

In response to receiving the QoS information, BS 810B may determine whether to admit or reject the associated traffic in operation 813. For example, BS 810B may determine to admit, partially admit, or reject the associated traffic based on, for example, its available offloading capability. In operation 815, BS 810B may transmit an admission, a partial admission, or a rejection (e.g., a rejection indication) of the associated traffic to BS 810A.

For example, BS 810B may completely admit the traffic and may feed back at least one of the following information to BS 810A:
for the UL ingress traffic, an egress BAP routing ID and egress BH RLC CH for each ingress BAP routing ID and ingress BH RLC CH;
for the DL egress traffic, an ingress BAP routing ID and ingress BH RLC CH for each egress BAP routing ID and egress BH RLC CH;
for the UL ingress traffic, an egress BAP routing ID and egress BH RLC CH for each F1-U tunnel; or
for the DL egress traffic, ingress BAP routing ID and ingress BH RLC CH for each F1-U tunnel.

In some embodiments, BS 810B may partially admit the traffic. In some examples, BS 810B may feed back at least one of the following information to BS 810A:
a list of unadmitted (or rejected) BAP routing IDs associated with BS 810A;
a list of unadmitted (or rejected) BH RLC CHs associated with BS 810A;
a list of unadmitted (or rejected) F1-U tunnels associated with BS 810A;
a list of admitted BAP routing IDs associated with BS 810A;
a list of admitted BH RLC CHs associated with BS 810A; or
a list of admitted F1-U tunnels associated with BS 810A.

The list of admitted BAP routing IDs, the list of admitted BH RLC CHs, and the list of admitted F1-U tunnels may further include the detailed information as described with respect to the completely admitted case. For example, a list of admitted BAP routing IDs may include an egress BAP routing ID for each admitted ingress BAP routing ID for the UL ingress traffic, and an ingress BAP routing ID for each admitted egress BAP routing ID for the DL egress traffic.

In some examples, although BS 810B partially admits the traffic, BS 810B may still feed back a complete mapping relationship as the one described with respect to the completely admitted case. For example, for the UL ingress traffic, an egress BAP routing ID and egress BH RLC CH for each ingress BAP routing ID and ingress BH RLC CH. BS 810B may transmit its available offloading capability to BS 810A such that BS 810A can determine the traffic to be offloaded to BS 810B. The available offloading capability can be reflected by an available bandwidth, an available transmission resource, the allowed number of BAP routing IDs, BH RLC CHs, or F1-U tunnels, or any combination thereof.

In operation 817, BS 810A may transmit a header rewriting configuration for inter-topology routing to network node 820. The configuration may be based on the information received in operation 815. For example, the header rewriting configuration for inter-topology routing includes a mapping between an old BAP routing ID associated with BS 810A (e.g., ingress BAP routing ID in the header rewriting configuration) and the corresponding new BAP routing ID associated with BS 810B (e.g., egress BAP routing ID in the header rewriting configuration). The header rewriting configuration for inter-topology routing may also indicate a next hop BAP address for the corresponding new BAP routing ID associated with BS 810B (e.g., egress BAP routing ID associated with BS 810B).

It should be appreciated by persons skilled in the art that the sequence of the operations in exemplary procedure 800 may be changed and some of the operations in exemplary procedure 800 may be eliminated or modified, without departing from the spirit and scope of the disclosure.

The text of the present disclosure mentions a header rewriting configuration for inter-topology routing and a header rewriting configuration for rerouting. It should be appreciated by persons skilled in the art that a network node may be configured with separate header rewriting configurations for inter-topology routing and rerouting, or a header rewriting configuration for both inter-topology routing and rerouting.

Embodiments of the present disclosure provide solutions to enhance the local rerouting procedure, which may take the intra-DU rerouting procedure and the header rewriting configuration based rerouting procedure (e.g., inter-DU rerouting) into consideration. For example, in some embodiments of the present disclosure, a network node may receive a packet to be transmitted by the network node. In some circumstances, for example, in response to the configured egress link suffering from an RLF or congestion, the network node may perform the enhanced rerouting procedure to transmit the packet so as to guarantee the latency requirement(s) of the traffic.

In some examples, the network node may select an entry in the BH routing configuration whose BAP address matches the DESTINATION field of the BAP header of the packet and whose BAP path ID is the same as the PATH field of the BAP header of the packet, but the egress link corresponding to the next hop BAP address of the selected entry may be unavailable (i.e., a failed routing procedure). The network node may then perform a local rerouting procedure based on at least one of the following procedures:
Rerouting option (a): an intra-DU rerouting procedure, including for example:
   Selecting an entry from the BH routing configuration whose BAP address is the same as the DESTINATION field of the BAP header of the packet, and whose egress link corresponding to the next hop BAP address of the entry is available.
Rerouting option (b): inter-DU rerouting, including for example:
   Rerouting option (b-1): inter-DU rerouting while the source DU and target DU are within the same CU.
   Rerouting option (b-2): inter-DU rerouting while the source DU and target DU are within different CUs.
   Whether option (b-1) or option (b-2) is employed may be left to the implementation of a BS (or CU). This is because the rerouting path is based on the header rewriting configuration for rerouting configured by the BS (or CU), and a network node may not know whether the egress link is terminated at a target DU in the same CU or a different CU.
Rerouting option (c): selecting an entry from the BH routing configuration whose egress link corresponding to the next hop BAP address is available.
   BAP header rewriting may be performed in rerouting option 3, for example, when the BAP address associated with the selected entry is different from that in the BAP header of a UL packet. For example, the BAP routing ID in the BAP header may be rewritten as the BAP routing ID of the selected entry.

In some embodiments of the present disclosure, performing rerouting option (b) may include, when there is an entry in the header rewriting configuration for rerouting whose ingress (old) BAP routing ID matches the BAP routing ID of the BAP header of the packet and the egress BH link corresponding to the egress (new) BAP routing ID is available, selecting the entry for rerouting. In the context of the disclosure, determining that the ingress BAP routing ID of an entry matches the BAP routing ID of the BAP header of a packet may include determining that the BAP address of the ingress BAP routing ID of the entry matches the DESTINATION field of the BAP header of the packet and determining that the BAP path ID of the ingress BAP routing ID of the entry matches the PATH field of the BAP header of the packet.

In some examples, as described above, the header rewriting configuration for rerouting may include the next hop BAP address for the egress (new) BAP routing ID. Thus, a network node can determine whether the egress link corresponding to the next hop BAP address of an entry is available or not based on the header rewriting configuration. In some other examples, the header rewriting configuration for rerouting may not include the next hop BAP address for the egress (new) BAP routing ID. The network node can make such determination based on the BH routing configuration.

In some embodiments of the present disclosure, a network node may not determine whether the egress link associated with the matched entry is available or not. For example, when the header rewriting configuration for rerouting does not include the next hop BAP address for the egress (new) BAP routing ID, performing rerouting option (b) may include, when there is an entry in the header rewriting configuration for rerouting whose ingress (old) BAP routing ID matches the BAP routing ID of the BAP header of the packet, selecting the entry for rerouting. That is, the network node does not identify the availability of the egress link, and will use the selected egress link for data transmission anyway.

Performing rerouting option (b) may further include performing a BAP header rewriting procedure based on the selected entry.

In some embodiments of the present disclosure, performing a local rerouting procedure based on at least one of rerouting option (a), (b) or (c) may include at least one of:
performing rerouting option (a), performing rerouting option (b) in response to (i) no available egress BH link being selected according to (a), and performing rerouting option (c) in response to (ii) no available egress BH link being selected according to rerouting option (b);
performing rerouting option (b) and performing rerouting option (c) in response to (ii);
performing rerouting option (a) and performing rerouting option (c) in response to (i); or
performing rerouting option (a) and performing rerouting option (b) in response to (i).

In some examples, a network node may perform a routing and a local rerouting procedure according to the following pseudo-code:

```
If there is an entry in the BH Routing Configuration whose BAP address matches the
  DESTINATION field, whose BAP path identity is the same as the PATH field, and
  whose egress link corresponding to the Next Hop BAP Address is available:
  - select the egress link corresponding to the Next Hop BAP Address of the entry;
Else if there is at least one entry in the BH Routing Configuration whose BAP address
  matches the DESTINATION field, and whose egress link corresponding to the
  Next Hop BAP Address is available:
  - select an entry from the BH Routing Configuration whose BAP address is the
    same as the DESTINATION field, and whose egress link corresponding to the
    Next Hop BAP Address is available;
  - select the egress link corresponding to the Next Hop BAP Address of the entry
    selected above;
Else if the Header Rewriting Configuration for rerouting is configured, and there is an
  entry in the Header Rewriting Configuration for rerouting whose BAP address
  matches the DESTINATION field, whose BAP path identity is the same as the
  PATH field, and whose egress link corresponding to the Next Hop BAP Address
  is available:
  - perform the BAP header rewriting operation;
  - select the egress link corresponding to the Next Hop BAP Address of the entry
    selected above;
Else select any entry from the BH Routing Configuration whose egress link
  corresponding to the Next Hop BAP Address is available.
```

In some circumstances, the BAP header rewriting may need to be performed twice at a boundary network node (e.g., IAB node 523 in FIG. 5 and IAB node 623 in FIG. 6) for inter-topology routing and rerouting. For example, as shown in FIG. 5, a UL packet may be planned to be transmitted in the right path, which means that the packet will be routed between two topologies. Thus, the BAP routing ID of the packet needs to be rewritten for inter-topology routing (first rewriting). However, if the egress link associated with the new BAP routing ID in the first rewriting is unavailable, the BAP entity may need to perform the BAP header rewriting once again for rerouting. Embodiments of the present disclosure provide solutions to enhance the BAP header rewriting procedure so that only a single BAP header rewriting is performed even in the above case.

In some embodiments of the present disclosure, when a network node receives a packet which needs to be routed between two topologies, the network node may first determine the availability of the egress link for the new BAP routing ID before performing a header rewriting, by, for example, checking the header rewriting configuration for inter-topology routing. Each entry of the header rewriting configuration for inter-topology routing may indicate an ingress (old) BAP routing ID, an egress (new) BAP routing ID, and a next hop BAP address for the egress BAP routing ID (optional).

For example, the network node may determine an egress BAP routing ID of an entry of the header rewriting configuration for inter-topology routing as new BAP routing ID #1 when the ingress BAP routing ID of the entry matches the BAP routing ID in the BAP header of the packet. If the egress link associated with new BAP routing ID #1 is available, the network node may perform a BAP header rewriting to rewrite the original BAP routing ID in the BAP header of the packet as new BAP routing ID #1, and route the packet with the new BAP header.

Otherwise, if the egress link associated with new BAP routing ID #1 is not available, the network node may not perform a BAP header rewriting and perform a rerouting procedure to transmit the packet. The network node may check the header rewriting configuration for rerouting to find an available egress link based on new BAP routing ID #1. Each entry of the header rewriting configuration for rerouting may indicate an ingress (old) BAP routing ID, an egress (new) BAP routing ID, and a next hop BAP address for the egress BAP routing ID (optional).

For example, when the ingress (old) BAP routing ID of an entry of the header rewriting configuration for rerouting matches new BAP routing ID #1, the network node may determine the egress (new) BAP routing ID of the entry as new BAP routing ID #2. If the egress link associated with new BAP routing ID #2 is available, the network node may perform a BAP header rewriting to rewrite the original BAP routing ID in the BAP header of the packet as new BAP routing ID #2, and reroute the packet with the new BAP header.

The egress link associated with the new BAP routing ID (e.g., new BAP routing ID #1 or new BAP routing ID #2) may correspond to the next hop BAP address for the new BAP routing ID in the corresponding header rewriting configuration. Accordingly, the network node may determine whether the egress link associated with the new BAP routing ID is available or not by determining whether the egress BH link corresponding to the next hop BAP address for the new BAP routing ID indicated by the configuration is available or not. Alternatively, the availability of the egress link may be determined based on the BH routing configuration.

In some examples, a network node may perform a BAP header rewriting procedure according to the following pseudo-code:

```
-If the Header Rewriting Configuration for inter-topology routing is
configured
  -If there is an entry in the Header Rewriting Configuration for
    inter-topology routing whose BAP address matches the
    DESTINATION field, whose BAP path identity is the same as the
    PATH field, and whose egress link corresponding to the Next Hop
    BAP Address is available:
    - perform the BAP header rewriting operation.
    - select the egress link corresponding to the Next Hop BAP Address
      and routing in the selected egress link.
  - Else if there is an entry in the Header Rewriting Configuration for
    rerouting whose BAP address matches the BAP address of new BAP
    routing ID in the Header Rewriting Configuration for inter-topology
    routing, whose BAP path identity is the same as the BAP path
    identity of new BAP routing ID in the Header Rewriting
    Configuration for inter-topology routing, and whose egress link
    corresponding to the Next Hop BAP Address is available:
    - perform the BAP header rewriting operation.
    - select the egress link corresponding to the Next Hop BAP Address
      and routing in the selected egress link.
```

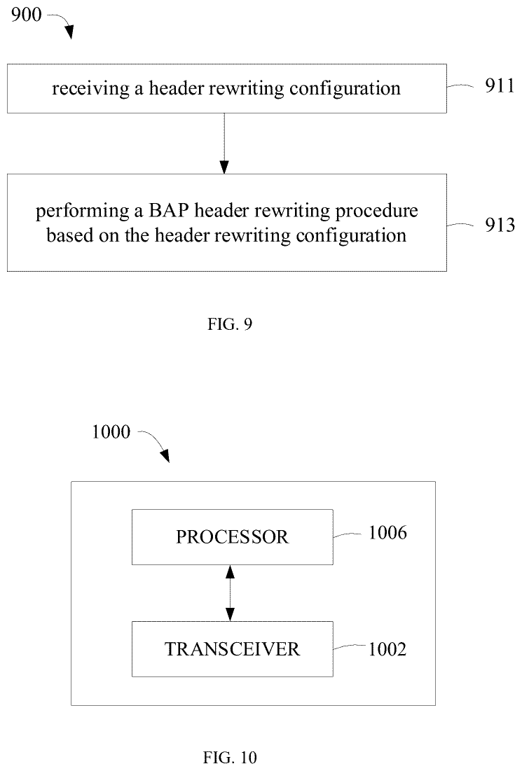

FIG. 9 illustrates a flow chart of an exemplary procedure 900 for wireless communications in accordance with some embodiments of the present disclosure. Details described in all of the foregoing embodiments of the present disclosure are applicable for the embodiments shown in FIG. 9.

Referring to FIG. 9, in operation 911, a network node may receive a header rewriting configuration. The header rewriting configuration may include at least one entry, each of which may indicate an ingress BAP routing ID and an egress BAP routing ID. In some embodiments of the present disclosure, each entry may further include a next hop BAP address for the egress BAP routing ID. In operation 913, the network node may perform a BAP header rewriting procedure based on the header rewriting configuration.

In some examples, the header rewriting configuration may include a header rewriting configuration for inter-topology routing and a header rewriting configuration for rerouting. In some examples, the header rewriting configuration may include a header rewriting configuration for both inter-topology routing and rerouting.

In some embodiments of the present disclosure, the network node may receive a data packet to be transmitted by the network node. The network node may perform a rerouting procedure to transmit the data packet by performing at least one of: (a) an intra-donor-distributed unit (DU) rerouting procedure; (b) a header rewriting configuration based rerouting procedure; or (c) selecting an available egress backhaul (BH) link to transmit the data packet according to a BH routing configuration for the network node.

Performing the rerouting procedure by performing at least one of (a), (b) or (c) may include at least one of: performing (a), performing (b) in response to (i) no available egress BH link being selected according to (a), and performing (c) in response to (ii) no available egress BH link being selected according to (b); performing (b) and performing (c) in response to (ii); performing (a) and performing (c) in response to (i); or performing (a) and performing (b) in response to (i).

Performing (b) may include: comparing a BAP routing ID in a BAP header of the data packet to an ingress BAP routing ID of an entry of the header rewriting configuration to determine a matched entry (e.g., entry #1A) of the header rewriting configuration; and in response to an egress BH link associated with entry #1A being available, selecting the egress BH link associated with entry #1A to transmit the data packet and performing the BAP header rewriting procedure.

In some embodiments of the present disclosure, the header rewriting configuration may include a header rewriting configuration for inter-topology routing and a header rewriting configuration for rerouting. The network node may receive a data packet to be routed between two topologies. The network node may compare a BAP routing ID in a BAP header of the data packet to an ingress BAP routing ID of an entry of the header rewriting configuration for inter-topology routing to determine a matched entry (e.g., entry #2B) of the header rewriting configuration for inter-topology routing; and in response to an egress BH link associated with entry #2B being unavailable, perform a rerouting procedure to transmit the data packet.

In some examples, determining the egress BH link associated with entry #2B being unavailable may include determining that an egress BH link corresponding to a next hop BAP address for an egress BAP routing ID of entry #2B is unavailable.

In some examples, performing the rerouting procedure may include: comparing an egress BAP routing ID of entry #2B to an ingress BAP routing ID of an entry of the header rewriting configuration for rerouting to determine a matched entry (e.g., entry #1B) of the header rewriting configuration for rerouting; and in response to an egress BH link associated with entry #1B being available, selecting the egress BH link associated with entry #1B to route the data packet and performing the BAP header rewriting procedure.

In some embodiments of the present disclosure, determining the egress BH link associated with a matched entry (e.g., entry #1A or entry #1B) being available may include determining that an egress BH link corresponding to a next hop BAP address for an egress BAP routing ID of the matched entry is available, and wherein performing the BAP header rewriting procedure may include rewriting the BAP routing ID in the BAP header of the data packet as the egress BAP routing ID of the matched entry.

It should be appreciated by persons skilled in the art that the sequence of the operations in exemplary procedure 900 may be changed and some of the operations in exemplary procedure 900 may be eliminated or modified, without departing from the spirit and scope of the disclosure.

FIG. 10 illustrates a block diagram of an exemplary apparatus 1000 according to some embodiments of the present disclosure.

As shown in FIG. 10, the apparatus 1000 may include at least one processor 1006 and at least one transceiver 1002 coupled to the processor 1006. The apparatus 1000 may be a network node (e.g., an IAB node) or a BS (e.g., an IAB donor, IAB donor-CU, or IAB donor-DU).

Although in this figure, elements such as the at least one transceiver 1002 and processor 1006 are described in the singular, the plural is contemplated unless a limitation to the singular is explicitly stated. In some embodiments of the present application, the transceiver 1002 may be divided into two devices, such as a receiving circuitry and a transmitting circuitry. In some embodiments of the present application, the apparatus 1000 may further include an input device, a memory, and/or other components.

In some embodiments of the present application, the apparatus 1000 may be a network node. The transceiver 1002 and the processor 1006 may interact with each other so as to perform the operations with respect to the network node or IAB node described in FIGS. 1-9. In some embodiments of the present application, the apparatus 1000 may be a BS. The transceiver 1002 and the processor 1006 may interact with each other so as to perform the operations with respect to the BS, the IAB donor, IAB donor-CU, or IAB donor-DU described in FIGS. 1-9.

In some embodiments of the present application, the apparatus 1000 may further include at least one non-transitory computer-readable medium.

For example, in some embodiments of the present disclosure, the non-transitory computer-readable medium may have stored thereon computer-executable instructions to cause the processor 1006 to implement the method with respect to the network node or IAB node as described above. For example, the computer-executable instructions, when executed, cause the processor 1006 interacting with transceiver 1002 to perform the operations with respect to the network node or IAB node described in FIGS. 1-9.

In some embodiments of the present disclosure, the non-transitory computer-readable medium may have stored thereon computer-executable instructions to cause the processor 1006 to implement the method with respect to the BS, the IAB donor, IAB donor-CU, or IAB donor-DU as described above. For example, the computer-executable instructions, when executed, cause the processor 1006 interacting with transceiver 1002 to perform the operations with respect to the BS, the IAB donor, IAB donor-CU, or IAB donor-DU described in FIGS. 1-9.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1.-15. (canceled)

16. A network node for wireless communication, comprising:
at least one memory; and
at least one processor coupled with the at least one memory and configured to cause the network node to:
receive a header rewriting configuration, wherein each entry of the header rewriting configuration indicates an ingress backhaul adaptation protocol (BAP) routing ID, an egress BAP routing ID, and a next hop BAP address for the egress BAP routing ID; and
perform a BAP header rewriting procedure based on the header rewriting configuration.

17. The network node of claim 16, wherein the header rewriting configuration includes a header rewriting configuration for inter-topology routing and a header rewriting configuration for rerouting, or the header rewriting configuration includes a header rewriting configuration for both inter-topology routing and rerouting.

18. The network node of claim 16, wherein the at least one processor is further configured to cause the network node to receive a data packet; and
perform a rerouting procedure to transmit the data packet by performing at least one of:
(a) an intra-donor-distributed unit (DU) rerouting procedure;
(b) a header rewriting configuration based rerouting procedure; or
(c) selecting an available egress backhaul (BH) link to transmit the data packet according to a BH routing configuration for the network node.

19. The network node of claim 18, wherein performing the rerouting procedure by performing at least one of (a), (b) or (c) comprises at least one of:
performing (a), performing (b) in response to (i) no available egress BH link being selected according to (a), and performing (c) in response to (ii) no available egress BH link being selected according to (b);
performing (b) and performing (c) in response to (ii);
performing (a) and performing (c) in response to (i); or
performing (a) and performing (b) in response to (i).

20. The network node of claim 18, wherein performing (b) comprises:
comparing a BAP routing ID in a BAP header of the data packet to an ingress BAP routing ID of an entry of the header rewriting configuration to determine a first matched entry of the header rewriting configuration; and
in response to an egress BH link associated with the first matched entry being available, selecting the egress BH link associated with the first matched entry to transmit the data packet and performing the BAP header rewriting procedure.

21. The network node of claim 16, wherein the header rewriting configuration includes a header rewriting configuration for inter-topology routing and a header rewriting configuration for rerouting; and
wherein the at least one processor is further configured to cause the network node to:
receive a data packet to be routed between two topologies;
compare a BAP routing ID in a BAP header of the data packet to an ingress BAP routing ID of an entry of the header rewriting configuration for inter-topology routing to determine a second matched entry of the header rewriting configuration for inter-topology routing; and
in response to an egress backhaul (BH) link associated with the second matched entry being unavailable, perform a rerouting procedure to transmit the data packet.

22. The network node of claim 21, wherein determining the egress BH link associated with the second matched entry being unavailable comprises determining that an egress BH link corresponding to a next hop BAP address for an egress BAP routing ID of the second matched entry is unavailable.

23. The network node of claim 21, wherein performing the rerouting procedure comprises:
comparing an egress BAP routing ID of the second matched entry to an ingress BAP routing ID of an entry of the header rewriting configuration for rerouting to determine a first matched entry of the header rewriting configuration for rerouting; and
in response to an egress BH link associated with the first matched entry being available, selecting the egress BH link associated with the first matched entry to route the data packet and performing the BAP header rewriting procedure.

24. The network node of claim 20, wherein determining the egress BH link associated with the first matched entry being available comprises determining that an egress BH link corresponding to a next hop BAP address for an egress BAP routing ID of the first matched entry is available, and wherein performing the BAP header rewriting procedure comprises rewriting the BAP routing ID in the BAP header of the data packet as the egress BAP routing ID of the first matched entry.

25. A first base station for wireless communication, comprising:
at least one memory; and
at least one processor coupled with the at least one memory and configured to cause the first base station to:
receive, from a second base station, information related to a backup backhaul adaptation protocol (BAP) routing ID for rerouting; and
transmit, to a network node connected to the first base station and the second base station, a header rewriting configuration for rerouting based on the received information.

26. The first base station of claim 25, wherein the at least one processor is further configured to cause the first base station to transmit, to the second base station, a request for the backup BAP routing ID for rerouting.

27. The first base station of claim 26, wherein the request for the backup BAP routing ID for rerouting indicates at least one of:
the number of backup BAP routing IDs; or
an identifier of the network node.

28. The first base station of claim 25, wherein the information related to the backup BAP routing ID for rerouting indicates at least one of:
at least one backup BAP routing ID associated with the second base station; or
a corresponding next hop BAP address for each of the at least one backup BAP routing ID associated with the second base station.

29. The first base station of claim 26, wherein the request for the backup BAP routing ID for rerouting indicates at least one of:
information related to at least one BAP routing ID associated with the first base station; or
an identifier of the network node.

30. The first base station of claim 25, wherein the information related to the backup BAP routing ID for rerouting indicates at least one of:
a mapping between each of at least one BAP routing ID associated with the first base station and a corresponding backup BAP routing ID associated with the second base station; or
a next hop BAP address for the corresponding backup BAP routing ID associated with the second base station.

31. The first base station of claim 25, wherein the header rewriting configuration for rerouting indicates a next hop BAP address for the backup BAP routing ID.

32. A second base station for wireless communication, comprising:
at least one memory; and
at least one processor coupled with the at least one memory and configured to cause the second base station to:
receive, from a first base station, a request for a backup backhaul adaptation protocol (BAP) routing ID for rerouting; and
transmit, to the first base station, information related to the backup BAP routing ID for rerouting.

33. The second base station of claim 32, wherein the request for the backup BAP routing ID for rerouting indicates at least one of:
the number of backup BAP routing IDs; or
an identifier of a network node connected to the first base station and the second base station.

34. The second base station of claim 32, wherein the information related to the backup BAP routing ID for rerouting indicates at least one of:
at least one backup BAP routing ID associated with the second base station; or
a corresponding next hop BAP address for each of the at least one backup BAP routing ID associated with the second base station.

35. A first base station for wireless communication, comprising:
at least one memory; and
at least one processor coupled with the at least one memory and configured to cause the first base station to:
transmit, to a second base station, quality of service (QOS) information of at least one of downlink (DL) traffic or uplink (UL) traffic for inter-topology routing; and
receive, from the second base station, a rejection or a partial admission of the at least one of DL traffic or UL traffic.
